(19) United States
(12) Patent Application Publication
(10) Pub. No.: US 2012/0273707 A1
(43) Pub. Date: Nov. 1, 2012

(54) Solenoid Valve for Controlling a Fluid

(75) Inventors: Elmar Vier, Freiberg A.N. (DE); Carsten Bodmann, Ludwigsburg (DE); Stephan Steingass, Bornheim (DE)

(73) Assignee: Robert Bosch GmbH, Stuttgart (DE)

(21) Appl. No.: 13/454,334

(22) Filed: Apr. 24, 2012

(30) Foreign Application Priority Data
Apr. 29, 2011 (DE) 10 2011 075 017.7

(51) Int. Cl. F16K 31/06

(52) U.S. Cl. 251/129.15

(57) ABSTRACT

A solenoid valve for controlling a fluid comprising an armature, a valve member which has a dome-shaped end region and which is connected to the a mature and is movable jointly with the armature, a first guidance region being provided on the armature, and a valve body with a valve seat, with a through orifice, the valve member opening and closing the through orifice on the valve seat, and with a guide element which defines a second guidance region for guiding the valve member and which guides the valve member when the solenoid valve is open, the guide element being formed in one piece with the valve body.

This application claims priority under 35 U.S.C. §119 to patent application no. DE 10 2011 075 017.7, filed on Apr. 29, 2011 in Germany, the disclosure of which is incorporated herein by reference in its entirety.

### BACKGROUND

The present disclosure relates to a solenoid valve for controlling a fluid.

Solenoid valves for controlling a fluid are known from the prior art in various embodiments, in particular, for example, as outlet valves for ABS/TCS/ESP devices in motor vehicles. In normal operation, valve members of these solenoid valves are usually guided in a conical valve seat of a valve body on an armature and by contact. In specific load or operating states, however, deformations of the valve member and/or damage to it in this case occur, particularly in medium to large stroke positions in which, in a partial stroke position, contact of the valve member with the valve body is possible. This may lead to an inadmissible impairment or variation of the valve function.

### SUMMARY

By contrast, the advantage of the solenoid valve according to the disclosure for controlling a fluid is that additional guidance of the valve member on the valve body is provided. As a result, the valve member can be forced to lift off from the valve seat even in the small stroke range. Furthermore, in the medium and large stroke range, the radial guidance forces are absorbed more effectively, so that contact between the valve member and valve body, particularly in partial stroke positions, and damage resulting from this are as far as possible prevented. This is achieved, according to the disclosure, in that the solenoid valve for controlling a fluid comprises an armature and a valve member. The valve member has a dome-shaped end region and is connected to the armature and is movable jointly with the armature on which a first guidance region is provided. The solenoid valve has, furthermore, a valve body with a valve seat and with a through orifice which is opened and closed by the valve member on the valve seat. Moreover, on the valve body, a guide element is provided which defines a second guidance region and which guides the valve member when the solenoid valve is open. In this case, the guide element is formed in one piece with the valve body. As a result, improved guidance of the valve member can be achieved in a simple way without additional components. Moreover, a marked shortening of the tolerance chain of the solenoid valve is thus achieved. Consequently, on account of the long guidance length thereby afforded, it is possible to achieve close and more exact guidance of the valve member. Furthermore, the sealing and guidance functions are distributed to different structural elements which are in each case non-critical in terms of load.

In a further advantageous refinement of the disclosure, the valve member has a guide portion which directly adjoins the dome-shaped end region in the axial direction and which can be guided on the second guidance region. Effective support or guidance can thereby be implemented at as short a distance as possible from a sealing line between the dome-shaped end region and the valve body. Since the radial guidance of the valve member whereby considerable loads have to be absorbed during hydraulic operation takes place outside the dome-shaped end region, the load which occurs can be diverted from a component region susceptible to damage to a component region which is non-critical in terms of damage.

Preferably, the guide portion on the valve member is of cylindrical or tapering, in particular conical, form. In addition to simple and cost-effective production, optimized contouring for interaction with the guide element on the valve body is thereby achieved.

According to a preferred refinement of the disclosure, the dome-shaped end region is arranged in a prespace provided between the guide element and the valve seat. In a further advantageous refinement of the disclosure, at least one outflow orifice is provided in a wall region of the prespace in the axial direction between the valve seat and the guide element. Favorable flow conditions at the dome-shaped end region of the valve member and also an operationally reliable outflow of the fluid are thereby achieved. Alternatively, a multiplicity of outflow orifices may be provided in the wall region. Moreover, the outflow orifices may be arranged in different numbers and with different shapes and may also be produced by means of any suitable production methods.

Preferably, in the closed state of the solenoid valve, an annular radial clearance is present between the guide portion of the valve member and the guide element on the valve body. As a result, mechanical contact with the guide element in the closed state is prevented or automatic location of the sealing position in the valve seat during the closing of the solenoid valve is achieved.

In a further advantageous refinement, the guide element is a peripheral annular collar. A valve body can thereby be provided which can be produced cost-effectively and economically and which is compatible with the previous installation situation. Moreover, this component can also be used for the conversion or retrofitting of existing construction series.

Preferably, a collar side directed toward the guide portion is rounded and forms the guidance region. Punctiform bearing contact of the valve member and therefore effective and operationally reliable guidance over the entire stroke range and over the entire angular range of the possible deflection of the valve member during normal operation are thereby achieved.

Preferably, furthermore, a restoring element is provided which is designed to keep the solenoid valve open when it is currentless.

According to a preferred refinement of the disclosure, the annular radial clearance is coordinate with the maximum stroke of the valve member and the seat angle on the valve body in such a way that the dome-shaped end region of the valve member lifts off from the valve seat even in the case of a small stroke, in particular from 50 to 70 μm. Furthermore, the acceleration travel and the impact momentum of the valve member, which comes into contact, deflected radially, with the valve seat in the minimum stroke range (in particular, from 0 to 50 μm), are low and therefore do not constitute any damaging load.

### BRIEF DESCRIPTION OF THE DRAWINGS

An exemplary embodiment of the disclosure is described in detail below with reference to the accompanying drawings in which:

FIG. 1 shows a diagrammatic sectional illustration of a solenoid valve for controlling a fluid according to a preferred exemplary embodiment of the disclosure.

FIG. 2 shows a diagrammatic sectional illustration of a valve body of the solenoid valve of FIG. 1.

FIG. 3 shows a diagrammatic partial view of the solenoid valve of FIG. 1 in the closed state.

FIG. 4 shows a diagrammatic partial view of the solenoid valve of FIG. 1 in a partially open state with a small opening stroke, and

FIG. 5 shows a diagrammatic partial view of the solenoid valve of FIG. 1 in a partially open state with a medium opening stroke.

### DETAILED DESCRIPTION

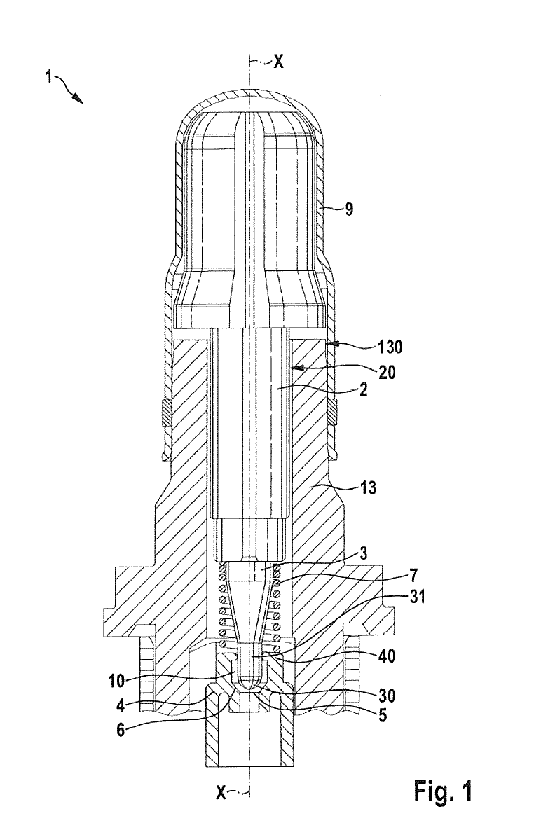

A solenoid valve for controlling a fluid according to a preferred exemplary embodiment of the disclosure is described in detail below with reference to FIGS. 1 to 5.

FIG. 1 shows a diagrammatic sectional illustration of a solenoid valve 1 for controlling a fluid according to a preferred exemplary embodiment of the disclosure.

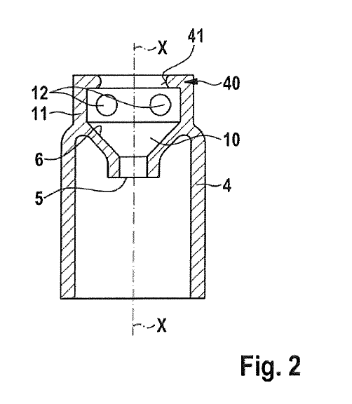

The solenoid valve 1 comprises an armature 2, a valve member 3 and a valve body 4 which are arranged coaxially to an axial direction X-X in a pole casing 9 or a casing 13 connected thereto. The armature 2 is in this case accommodated in the pole casing 9 and in the casing 13. The valve member 3 is connected to the armature 2 and is movable jointly with the latter. A first guidance region 20 for guiding the armature 2 is provided, level with a first end region 130 of the casing 13, on the armature 2. The valve member 3 has a dome-shaped end region 30 and a cylindrical guide portion 31 which adjoins the dome-shaped end region 30 directly in the axial direction X-X. The valve body 4 has a valve seat 6 and a through orifice 5 which is opened and closed by the valve member 3. Moreover, the valve body 4 has a guide element 40 which is formed in one piece with the valve body 4 and which forms a second guidance region 41 (see FIG. 2) for guiding the valve member 3. Provided in the axial direction X-X between the guide element 40 and the armature 2 is a restoring element 7 which keeps the solenoid valve 1 open in the currentless state. As is also clear from FIG. 1, the dome-shaped end region 30 is arranged in a prespace 10 formed between the guide element 40 and the valve seat 6.

As is evident from FIG. 2, a plurality of outflow orifices 12 are arranged in a wall region 11 of the prespace 10. The second guidance region 41 is designed as a peripheral annular collar of which a collar side directed radially to the axial direction X-X is rounded. This contouring ensures operationally reliable punctiform guidance contact with the cylindrical guidance region 31 even in the case of an angular orientation (or skewing) of the valve member 3 which deviates slightly from the axial direction X-X during normal operation.

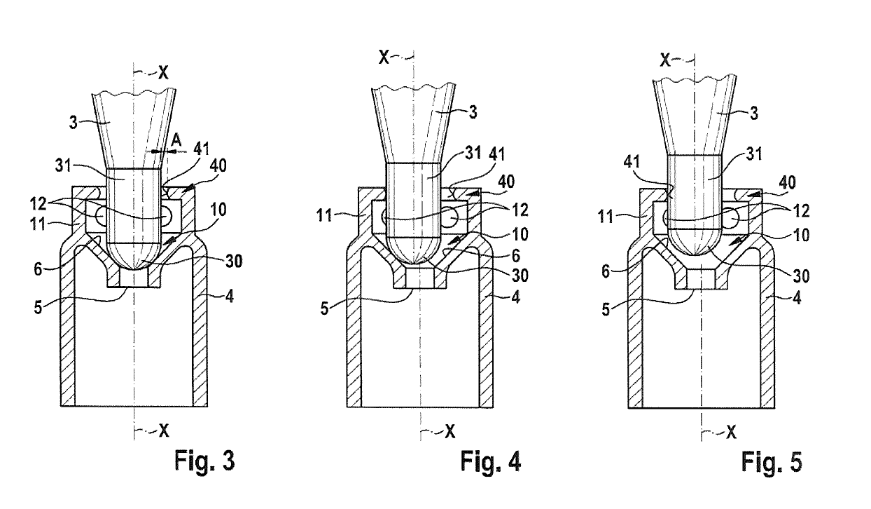

As illustrated in FIG. 3, in the closed state of the solenoid valve 1 the dome-shaped end region 30 lies on the valve seat 6 and closes the through orifice 5. In this case, an annular radial clearance A is present between the guide portion 31 of the valve member 3 and the second guidance region 41, that is to say the guide portion 31 of the valve member 3 is not guided.

FIG. 4 shows a configuration of the valve body 6 and the valve member 3 shortly after the opening of the solenoid valve with a minimum stroke up to 70 μm, that is to say immediately before the dome-shaped end region 30 is lifted off from the valve seat 6. In this case, the dome-shaped end region 30, deflected laterally, still just touches the valve seat 6, but is also already in contact with the collar side of the second guidance region 41 and consequently, with an increasing valve stroke, must lift off completely from the valve seat 6 immediately after this position. The guidance region 41 of the guide element 40 is designed geometrically such that contact of the dome-shaped end region 30 with the valve seat 6 is possible, if at all, only in the minimum stroke range, in particular up to approximately 50 to 70 μm, immediately after opening, and the valve member 3 lifts off from the valve seat 6 as quickly as possible.

In the partial opening range with a medium and large stroke, which is illustrated in FIG. 5, the guide portion 31 of the valve member 3 is continually guided radially on the guidance region 41 of the guide element 40. Contact of the dome-shaped end region 30 of the valve member 3 with the valve seat 6 is therefore no longer possible. Conversely, during the operation of closing the solenoid valve 1, guidance of the valve member 3 on the guidance region 41 occurs only up to the minimum stroke of 70 to 50 μm. Thereafter, the dome-shaped end region 30 is in contact with the conical valve seat 6 and, as the stroke decreases further, is guided along the surface of the latter into the sealing position (zero stroke), without in this case coming to bear against the guidance region 41.

The solenoid valve 1 according to the disclosure thus has the advantage that a large part of the tolerance chain (such as, for example, fitting position and skewing) is avoided on account of the second guide element 40 formed integrally on the valve body 4. Furthermore, because of the long guidance length between the first and second guidance regions 20, 40, it is possible to permit close guidance of the valve member 3 and to distribute the sealing and guidance functions to different structural elements which are in each case non-critical in terms of load. Furthermore, contact or butting of the dome-shaped end region 30 on the valve seat 6 and also the loads or damage resulting from this are prevented essentially over the entire stroke range of the solenoid valve 1. This results in considerably improved operational reliability and long-term durability of the solenoid valve 1.

What is claimed is:

1. A solenoid valve for controlling a fluid comprising:
an armature;
a valve member which has a dome-shaped end region and which is connected to the armature and is movable jointly with the armature, a first guidance region being provided on the armature; and
a valve body, the valve body including,
a valve seat,
a through orifice, the valve member opening and closing the through orifice on the valve seat, and
a guide element which defines a second guidance region for guiding the valve member and which guides the valve member when the solenoid valve is open, the guide element being formed in one piece with the valve body.

2. The solenoid valve according to claim 1, wherein the valve member has a guide portion which directly adjoins the dome-shaped end region in the axial direction and which can be guided on the second guidance region.

3. The solenoid valve according to claim 2, wherein the guide portion on the valve member is one of cylindrical, tapering, and conical form.

4. The solenoid valve according claim 1, wherein the guide element and the valve seat define a prespace into which the dome-shaped end region is arranged.

5. The solenoid valve according to claim 4, wherein the prespace is bounded by a wall region that defines at least one outflow orifice in the axial direction between the valve seat and the guide element.

6. The solenoid valve according to claim 2, wherein the guide portion of the valve and the guide element define an annular clearance that is radial to the axial direction when the solenoid valve is in a closed state.

7. The solenoid valve according claim 1, wherein the guide element is a peripheral annular collar.

8. The solenoid valve according to claim 7, wherein the guide element has a collar side that is directed toward the guide portion and that is rounded and forms the guidance region.

9. The solenoid valve according to claim 1, further comprising a restoring element which is configured to keep the solenoid valve open when the solenoid valve is currentless.

10. The solenoid valve according to claim 6, wherein the annular clearance is smaller than a maximum stroke of the valve member.
